(19) United States
(12) Patent Application Publication
(10) Pub. No.: US 2004/0177374 A1
(43) Pub. Date: Sep. 9, 2004

(54) Apparatus for controlling digital transport stream on digital settop box

(76) Inventors: Ho-Hyun Park, Yongin-city (KR); Jae-Seok Park, Seoul (KR); Hyun-Chul Kim, Suwon-city (KR)

Correspondence Address: Robert E. Bushnell, Suite 300, 1522 K Street, N.W., Washington, DC, 20005, US

(21) Appl. No.: 10/727,639

(22) Filed: Dec. 5, 2003

(30) Foreign Application Priority Data
Mar. 7, 2003 (KR) 14448/2003

(51) Int. Cl. H04N 7/18; H04N 7/173

(52) U.S. Cl. 725/74; 725/82; 725/80; 725/90

(57) ABSTRACT

An apparatus for controlling a digital transport stream on a digital settop box has independent properties in network construction between a broadcasting HE equipment or VOD server and the settop box, by controlling network interfaces and streams for both an ATM network and an IP network on one xDSL settop box. The apparatus can smoothly cope with network construction by providing services in an ATM mode in an environment requiring high quality of service, and in an IP mode in an environment requiring a low network building cost. When the broadcasting is connected to the ATM network and the VOD is connected to the IP network, the apparatus can provide services without incorporating the networks. In addition, as compared with the ATM mode, the IP mode processes decapsulation and IP routing of an MPEG transport stream packet in a software type, and thus does not require special hardware. That is, both the ATM mode and the IP mode can be controlled in the same hardware construction as the ATM mode. When the network is connected through the Ethernet without using the xDSL, the apparatus can provide the broadcasting or VOD service in the IP mode.

### CLAIM OF PROPERTY

This application claims priority to an application entitled APPARATUS FOR CONTROLLING DIGITAL TRANSPORT STREAM ON DIGITAL SETTOP BOX, filed in the Korean Intellectual Property Office on the 7^{th} of Mar. 2003 and assigned Serial No. 2003-14448, the contents of which are hereby incorporated by reference.

### BACKGROUND OF INVENTION

1. Technical Field

The present invention relates to a digital settop box, and more particularly to an apparatus controlling network interfaces and streams for both an asynchronous transfer mode (ATM) network and also an Internet protocol (IP) network when a digital broadcasting or video on demand (VOD) stream is supplied to the digital settop box through a digital subscriber line protocol (xDSL).

2. Related Art

Generally, a digital settop box implies a home communication terminal necessary to use next generation bi_directional multimedia communication services such as video on demand (VOD), video home shopping and network games, sometimes also referred to as interactive television.

The digital settop box is connected to a bi_directional television (TV) or video transmission service network of a telephone company (for example, video dial tone provided by telephone companies in the United States), and also connected to a television monitor for home uses. The digital settop box has basic functions of video signal reception/transformation as well as a function of communicating with a video server of a telephone company or cable television (CATV).

Improvements can be contemplated to expand the usefulness, convenience, and efficiency of settop boxes and related technologies. Exemplars of recent efforts in the art are disclosed, for example, in U.S. Pat. No. 6,535,927 to Kim, entitled SYSTEM FOR PROCESSING PROTOCOL FOR INTERNET SERVICES EMPLOYING SERIAL LINE AND ATM NETWORK, issued on Mar. 18, 2003, U.S. Pat. No. 6,285,685 to Bum, entitled APPARATUS AND METHOD FOR PROVIDING PC COMMUNICATION AND INTERNET SERVICE BY USING SETTOP BOX, issued on Sep. 4, 2001, U.S. Pat. No. 6,084,876 to Kwok et al., entitled DYNAMIC ATM CONNECTION MANAGEMENT IN A HYBRID FIBER-COAX CABLE NETWORK, issued on Jul. 4, 2000, and U.S. Pat. No. 6,530,086 to Brodigan, entitled SYSTEM AND METHOD FOR VDSL REAL TIME RESPONSE TO VIDEO PROGRAMMING, issued on Mar. 4, 2003.

While these contemporary efforts contain merit, further improvements can also be contemplated.

### SUMMARY OF THE INVENTION

The present invention provides an apparatus for controlling a digital transport stream on a digital settop box which can control a digital broadcasting or video on demand (VOD) stream regardless of asynchronous transfer mode (ATM) and Internet protocol (IP) modes, when the stream is supplied to the digital settop box through a digital subscriber line protocol (xDSL).

The present invention provides an apparatus for controlling a digital transport stream on a digital settop box which can process asynchronous transfer mode (ATM) mode data for guaranteeing quality of service in a hardware type, and Internet protocol (IP) mode data for building a system at a low price in a combination type of hardware and software, when a digital broadcasting or VOD stream is supplied to the digital settop box through a digital subscriber line protocol (xDSL).

The present invention provides an apparatus for controlling a digital transport stream on a digital settop box, including: a data receiving means connected to a digital subscriber line protocol (xDSL) port and an Ethernet port, for receiving an asynchronous transfer mode (ATM) or Internet protocol (IP) mode digital broadcasting or VOD data from an ATM network or IP network, and deciding whether the received data is an ATM data, IP over ATM data or IP data; an ATM cell extracting means for deciding whether the data transmitted from the data receiving means is an ATM mode Moving Picture Experts Group (MPEG) transport stream or IP packet data, and extracting valid cells from ATM cells for the MPEG transport stream; a transport stream forming means for forming an MPEG transport stream by removing a predetermined byte of head information and overhead information from the valid cells extracted by the ATM cell extracting means, and re_assembling the ATM cells whose overhead information has been removed; and a data transforming means for transforming the MPEG transport stream transmitted from the transport stream forming means to be played back on a video display. Here, when the ATM cell is an MPEG transport stream, the ATM cell extracting means compares virtual path identifier/virtual channel identifier (VPINCI) values corresponding to addresses ofthe ATM cells, and extracts the valid cells.

The present invention provides a data receiving means that includes a digital subscriber line protocol (xDSL) receiving unit for receiving the asynchronous transfer mode (ATM) data and Internet protocol (IP) packet data through an xDSL interface; and an Ethernet receiving unit for receiving the IP packet data through an Ethernet interface.

The present invention provides a data transforming means that includes: a decoding unit for decoding the Moving Picture Experts Group (MPEG) transport stream transmitted from the transport stream forming means; and an encoding unit for encoding the MPEG transport stream decoded by the decoding unit to be played back on the video display.

The apparatus of the present invention further includes a media access control (MAC) processing means for extracting valid cells from the received Internet protocol (IP) packet, when receiving the IP over asynchronous transfer mode (ATM) mode or IP mode data through the digital subscriber line protocol (xDSL) port of the data receiving means, or the IP packet data through the Ethernet port.

The apparatus of the present invention further includes a control means for identifying whether the asynchronous transfer mode (ATM) mode Internet protocol (IP) packet ATM cell extracted by the ATM cell extracting means, and the IP over ATM mode or IP mode IP packet cell processed by the media access control (MAC) processing means are Moving Picture Experts Group (MPEG) transport streams or general Internet data, re_assembling the cells in accordance with the aforementioned identifying, and transmitting the MPEG transport stream to the decoding unit and the general Internet data to the encoding unit.

In accordance with the principles of the present invention, as embodied and broadly described, the present invention provides an apparatus controlling a digital transport stream on a digital settop box, the apparatus comprising: a data receiving unit being connected to a digital subscriber line port and an Ethernet port, said data receiving unit receiving signals from at least one selected from among an asynchronous transfer mode network and an Internet protocol network, the signals corresponding to at least one selected from among asynchronous transfer mode digital broadcasting, asynchronous transfer mode video on demand, Internet protocol mode digital broadcasting, and Internet protocol video on demand, said data receiving unit identifying the received signals by determining when the received signals are asynchronous transfer mode data, when the received signals are Internet protocol over asynchronous transfer mode data, and when the received signals are Internet protocol data, said data receiving unit transmitting information corresponding to the received signals in dependence upon the identifying; an extracting unit determining when the transmitted information corresponds to a portion of a Moving Picture Experts Group transport stream and when the transmitted information corresponds to Internet protocol packet data, said extracting unit extracting valid cells from asynchronous transfer mode cells when the transmitted information includes asynchronous transfer mode cells; a transport stream forming unit receiving the extracted valid cells, modifying the extracted valid cells to form modified cells, the modifying including removing a predetermined byte of head information and overhead information from the extracted valid cells, forming the Moving Picture Experts Group transport stream by re_assembling the modified cells; and a data transforming unit transforming the Moving Picture Experts Group transport stream transmitted from said transport stream forming unit to be displayed by a video display.

In accordance with the principles of the present invention, as embodied and broadly described, the present invention provides an apparatus, comprising: a data receiving unit being connected to at least two ports, said data receiving unit receiving signals from at least one selected from among an asynchronous transfer mode network and an Internet protocol network, the signals corresponding to at least one selected from among asynchronous transfer mode digital broadcasting, asynchronous transfer mode video on demand, Internet protocol mode digital broadcasting, and Internet protocol video on demand, said data receiving unit identifying the received signals by determining when the received signals are asynchronous transfer mode data, when the received signals are Internet protocol over asynchronous transfer mode data, and when the received signals are Internet protocol data, said data receiving unit transmitting information corresponding to the received signals in dependence upon the identifying; an extracting unit determining when the transmitted information corresponds to a portion of a Moving Picture Experts Group transport stream and when the transmitted information corresponds to Internet protocol packet data, said extracting unit extracting valid cells from asynchronous transfer mode cells when the transmitted information includes asynchronous transfer mode cells; and a transport stream forming unit receiving the extracted valid cells, modifying the extracted valid cells to form modified cells, the modifying including removing a predetermined information from the extracted valid cells, forming the Moving Picture Experts Group transport stream by re_assembling the modified cells, and outputting video data to be transformed and then displayed by a video display.

In accordance with the principles of the present invention, as embodied and broadly described, the present invention provides an apparatus, comprising: a data receiving unit being connected to a digital subscriber line port and an Ethernet port, said data receiving unit receiving signals from at least one selected from among an asynchronous transfer mode network and an Internet protocol network, the signals corresponding to at least one selected from among asynchronous transfer mode digital broadcasting, asynchronous transfer mode video on demand, Internet protocol mode digital broadcasting, and Internet protocol video on demand; said data receiving unit identifying the received signals by determining when the received signals are asynchronous transfer mode data, when the received signals are Internet protocol over asynchronous transfer mode data, and when the received signals are Internet protocol data; said data receiving unit transmitting information corresponding to the received signals in dependence upon the identifying; an extracting unit determining when the transmitted information corresponds to a transport stream and when the transmitted information corresponds to Internet protocol packet data, said extracting unit extracting valid cells from asynchronous transfer mode cells when the transmitted information includes asynchronous transfer mode cells; and a transport stream forming unit receiving the extracted valid cells, modifying the extracted valid cells to form modified cells, the modifying including removing predetermined information from the extracted valid cells, forming the transport stream by re_assembling the modified cells; and a data transforming unit transforming the transport stream transmitted from said transport stream forming unit to be displayed by a video display.

The present invention is more specifically described in the following paragraphs by reference to the drawings attached only by way of example. Other advantages and features will become apparent from the following description and from the claims.

### BRIEF DESCRIPTION OF THE DRAWINGS

In the accompanying drawings, which are incorporated in and constitute a part of this specification, embodiments of the invention are illustrated, which, together with a general description of the invention given above, and the detailed description given below, serve to exemplify the principles of this invention.

FIG. 1 is a block diagram illustrating an apparatus for controlling a digital transport stream on a digital settop box, in accordance with the principles of the present invention;

FIG. 2 illustrates a protocol stack structure for transmitting a Moving Pictures Expert Group (MPEG) transport stream through an asynchronous transfer mode (ATM) mode digital subscriber line protocol (xDSL), in accordance with the principles of the present invention;

FIG. 3 illustrates a protocol stack structure for transmitting an Internet protocol (IP) over asynchronous transfer mode (ATM) based Moving Pictures Expert Group (MPEG) transport stream through the asynchronous transfer mode (ATM) mode digital subscriber line protocol (xDSL), in accordance with the principles of the present invention;

FIG. 4 illustrates a protocol stack structure for transmitting a Moving Pictures Expert Group (MPEG) transport stream in an Internet protocol (IP) mode, in accordance with the principles of the present invention; and

FIG. 5 is a flowchart showing sequential steps of a method for controlling a digital transport stream on a digital settop box, in accordance with the principles of the present invention.

### DESCRIPTION OF BEST MODE OF CARRYING OUT THE INVENTION

While the present invention will be described more fully hereinafter with reference to the accompanying drawings, in which details of the present invention are shown, it is to be understood at the outset of the description which follows that persons of skill in the appropriate arts may modify the invention here described while still achieving the favorable results of this invention. Accordingly, the description of the best mode contemplated of carrying out the invention, which follows, is to be understood as being a broad, teaching disclosure directed to persons of skill in the appropriate arts, and not as limiting upon the present invention.

Illustrative embodiments of the best mode of carrying out the invention are described below. In the interest of clarity, not all features of an actual implementation are described. In the following description, well-known functions, constructions, and configurations are not described in detail since they could obscure the invention with unnecessary detail. It will be appreciated that in the development of any actual embodiment numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill having the benefit of this disclosure.

In technologies for use with a digital settop box and bi-directional television, it is noted that video and voice data for digital broadcasting are compressed by the Moving Picture Experts Group 2 (MPEG2), multiplexed in a transport stream type, and transmitted through a digital subscriber line protocol (xDSL). Here, the xDSL includes asymmetric digital subscriber line (ADSL), high bit-rate digital subscriber line (HDSL), very high bit-rate digital subscriber line (VDSL), and other digital subscriber line protocols.

The video on demand (VOD) includes Internet VOD which allows users to watch Internet VOD contents through a Windows Media (™) player or RealPlayer (™), and MPEG2 VOD.

Various kinds of Moving Picture Experts Group 2 (MPEG2) video on demand (VOD) exist. However, identically to the digital broadcasting, a VOD steam is multiplexed in an MPEG2 transport stream packet type, and transmitted to the digital settop box according to an asynchronous transfer mode (ATM) or Internet protocol (IP) mode.

Most of the general xDSL settop boxes are used for the VOD service, and support only a single mode. That is, most of the general xDSL settop boxes support either ATM mode or IP mode. Accordingly, the settop boxes must be individually installed if a user ever wants to process both the ATM mode and the IP mode.

Costs are increased when it is necessary to purchase separate settop boxes. That is, when a user want to process both ATM mode and IP mode, that user will need to purchase and install two settop boxes.

The best mode of carrying out the present invention will be described herein below with reference to the accompanying drawings. In the following description, well_known functions and constructions are not described in detail since they would obscure the invention in unnecessary detail.

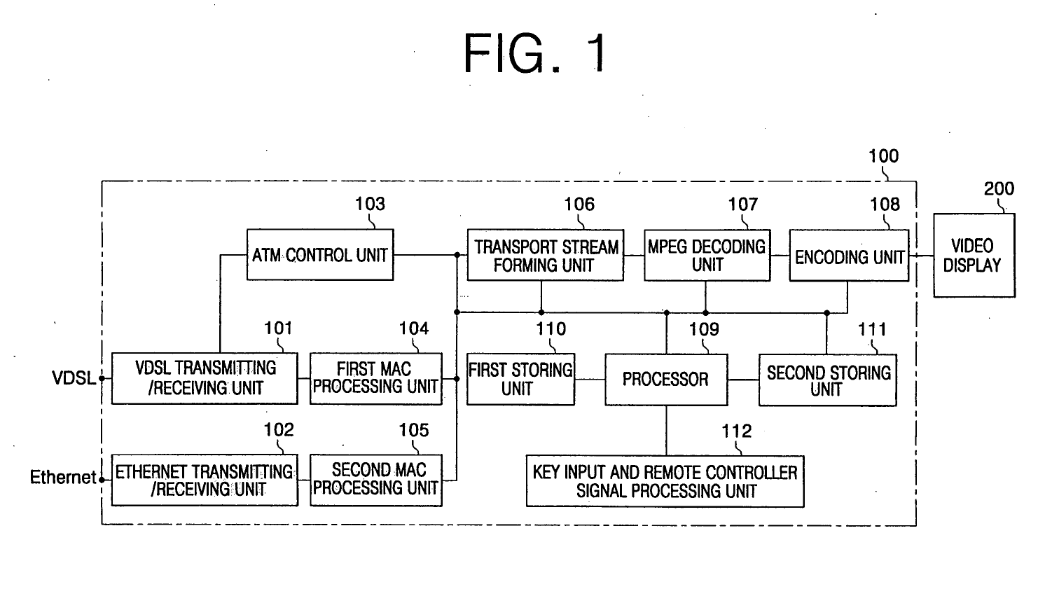

FIG. 1 is a block diagram illustrating an apparatus for controlling a digital transport stream on a digital settop box, in accordance with the principles of the present invention. Referring to FIG. 1, the apparatus for controlling the digital transport stream on the digital settop box includes a very high bit-rate digital subscriber line (VDSL) transmitting/receiving unit 101, an Ethernet transmitting/receiving unit 102, an asynchronous transfer mode (ATM) control unit 103, first and second media access control (MAC) processing units 104 and 105, a transport stream forming unit 106, a Moving Picture Expert Group (MPEG) decoding unit 107, an encoding unit 108, a processor 109, first and second storing units 110 and 111, and a key input and remote controller signal processing unit 112. The digital settop box 100 is connected to a video display 200. All kinds of displays which can display videos such as television (TV) and computer can be used as the video display.

The very high bit-rate digital subscriber line (VDSL) transmitting/receiving unit 101 is connected to an ATM network, for receiving ATM or IP mode digital broadcasting or VOD data from the ATM network. When the received data is an ATM data or IP over ATM data, the VDSL transmitting/receiving unit 101 transmits the data to the ATM control unit 103, and when the received data is an IP packet data, the VDSL transmitting/receiving unit 101 transmits the data to the first MAC processing unit 104. The unit 101 can identify the data received by the unit 101. That is, the unit 101 can determine the type of data that is received by the unit 101.

The Ethernet transmitting/receiving unit 102 is connected to an IP network, for receiving an IP based data and transmitting the data to the second MAC processing unit 105. The unit 102 can identify the data received by the unit 102. That is, the unit 102 can determine the type of data that is received by the unit 102.

The ATM control unit 103 decides or determines whether the data transmitted from the very high bit-rate digital subscriber line (VDSL) transmitting/receiving unit 101 is an ATM cell or IP packet data. When the data is the ATM cell, the ATM control unit 103 decides whether the ATM cell is a portion of a Motion Picture Experts Group (MPEG) transport stream or is IP packet data. When the ATM cell is a portion of the MPEG transport stream, the ATM control unit 103 compares virtual path identifier (VPI)/virtual channel identifier(VCI) values corresponding to addresses of the ATM cells, extracts valid cells, and transmits the valid cells to the transport stream forming unit 106. Then the transport stream forming unit 106 can form the transport stream.

In addition, when the asynchronous transfer mode (ATM) cell is the IP packet data, the ATM control unit 103 decides whether the IP packet is a Motion Picture Experts Group (MPEG) transport stream or general Internet data. When the IP packet is a portion of the MPEG transport steam, the ATM control unit 103 transmits the MPEG transport stream to the MPEG decoding unit 107 through the processor 109. When the IP packet is the general Internet data, the ATM control unit 103 transmits the data to the encoding unit 108 through the processor 109.

The first MAC processing unit 104 decides whether the IP packet data transmitted from the very high bit-rate digital subscriber line (VDSL) transmitting/receiving unit 101 is a portion of a Motion Picture Experts Group (MPEG) transport stream or general Internet data. When the IP packet is a portion of a MPEG transport stream, the first MAC processing unit 104 transmits the transport stream to the MPEG decoding unit 107 through the processor 109. When the IP packet is the general Internet data, the first MAC processing unit 104 transmits the data to the encoding unit 108 through the processor 109.

The second MAC processing unit 105 decides or determines whether the IP packet data transmitted from the Ethernet transmitting/receiving unit 102 is a portion of a Motion Picture Experts Group (MPEG) transport stream or general Internet data. When the IP packet is a portion of the MPEG transport stream, the second MAC processing unit 105 transmits the transport stream to the MPEG decoding unit 107 through the processor 109. When the IP packet is the general Internet data, the second MAC processing unit 105 transmits the data to the encoding unit 108 through the processor 109.

The transport stream forming unit 106 removes heads of the asynchronous transfer mode (ATM) cells transmitted from the ATM control unit 103, removes overhead information from a predetermined bit of payloads whose heads have been removed, reassembles four ATM cells to form a Motion Picture Experts Group (MPEG) transport stream, and transmits the MPEG transport stream to the MPEG decoding unit 107 in a physical MPEG transport stream type. Here, the ATM cell has 53 bytes, the head has 5 bytes and the overhead has 1 byte. In addition, the four reassembled ATM cells whose overheads have been removed can compose 188 bytes of MPEG transport stream.

The processor 109 reassembles the IP packet data of the asynchronous transfer mode (ATM) cell transmitted from the ATM control unit 103, namely cells of the Motion Picture Experts Group (MPEG) transport stream or general Internet data, transmits the reassembled MPEG transport stream packet to the MPEG decoding unit 107, and transmits the reassembled general Internet data packet to the encoding unit 108.

In addition, the processor 109 packetizes cells ofthe IP packets transmitted from the first and second MAC processing units 104 and 105, provides the Motion Picture Experts Group (MPEG) transport stream to the MPEG decoding unit 107, and transmits the general Internet data to the encoding unit 108. Here, when transmitting the general Internet data to the encoding unit 108, the processor 109 performs a routing function as a very high bit-rate digital subscriber line (VDSL) modem.

The MPEG decoding unit 107 decodes the Motion Picture Experts Group (MPEG) transport streams transmitted from the transport stream forming unit 106 and the processor 109, transmits the decoded transport streams to the encoding unit 108. The encoding unit 108 encodes the data transmitted from the MPEG decoding unit 107 and the processor 109 to be displayed on the video display 200, and transmits the encoded data to the video display 200.

The first and second storing units 110 and 111 store all programs and OS for driving the processor 109. The key input and remote controller signal processing unit 112 processes a key input signal and a remote controller signal for controlling the settop box inputted by the user, and transmits the corresponding signal to the processor 109. Here, a random access memory (RAM) can be used as the first storing unit 110, and a flash memory can be used as the second storing unit 111.

The operation for controlling the digital transport stream on the digital settop box in accordance with the present invention will now be explained in detail.

The xDSL includes ADSL, HDSL and very high bit-rate digital subscriber line (VDSL). The present invention presumes asymmetric VDSL to receive 19.39 mega bits per second (Mbps) of high definition (HD) level broadcasting.

Various methods for transmitting an MPEG2 transport stream through the very high bit-rate digital subscriber line (VDSL) can be embodied. The present invention will now be explained by referring to the following three examples.

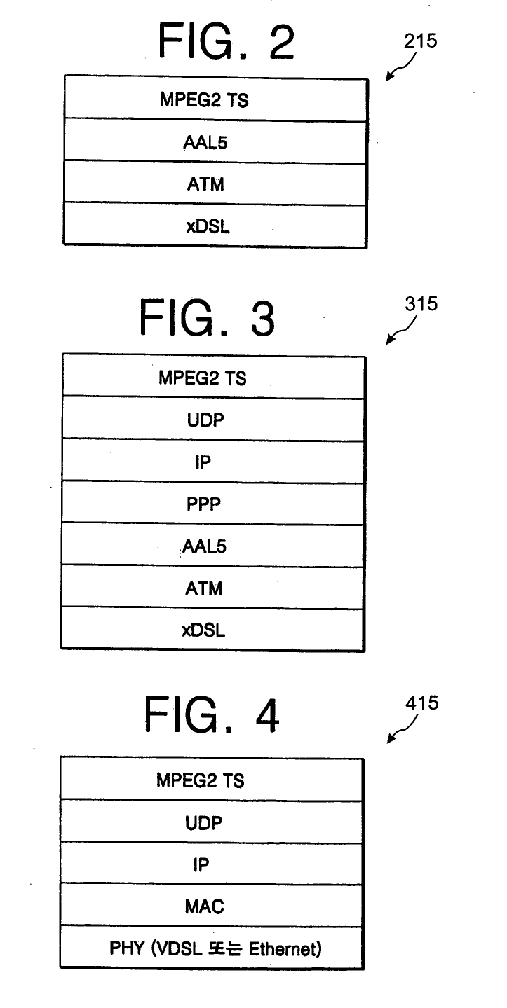

FIG. 2 illustrates a protocol stack structure for transmitting a Moving Pictures Expert Group (MPEG) transport stream through an asynchronous transfer mode (ATM) mode digital subscriber line protocol (xDSL), in accordance with the principles of the present invention. FIG. 2 illustrates a protocol stack structure 215 for transmitting an MPEG2 transport stream through an ATM mode xDSL.

FIG. 3 illustrates a protocol stack structure for transmitting an Internet protocol (IP) over asynchronous transfer mode (ATM) based Moving Pictures Expert Group (MPEG) transport stream through the asynchronous transfer mode (ATM) mode digital subscriber line protocol (xDSL), in accordance with the principles of the present invention. FIG. 3 illustrates a protocol stack structure 315 for transmitting an IP over ATM based MPEG2 transport stream through the ATM mode xDSL.

FIG. 4 illustrates a protocol stack structure for transmitting a Moving Pictures Expert Group (MPEG) transport stream in an Internet protocol (IP) mode, in accordance with the s principles of the present invention. FIG. 4 illustrates a protocol stack structure 415 for transmitting an MPEG2 transport stream in an IP mode.

The first example transmits the Motion Picture Experts Group (MPEG) transport stream in the asynchronous transfer mode (ATM) mode. As shown in FIG. 2, an ATM layer is positioned on an xDSL layer, an “ATM adaption layer 5”(AAL5) layer is positioned on the ATM layer, and an MPEG transport stream is positioned on the AAL5 layer.

The second example transmits the Motion Picture Experts Group (MPEG) transport stream in the IP over ATM mode. As illustrated in FIG. 3, an ATM layer and an AAL5 layer are positioned on an xDSL layer, and an IP layer is positioned on the AAL5 layer. A point to point protocol (PPP) layer is necessary to position the IP layer on the ATM layer and the AAL5 layer. In addition, transmission control protocol (TCP) and user datagram protocol (UDP) layers can be used as transport layers for transmitting an MPEG transport stream on the IP layer. The UDP layer is suitable for broadcasting and VOD data transmission.

The third example transmits the Motion Picture Experts Group (MPEG) transport stream in the IP mode. As depicted in FIG. 4, a MAC layer is positioned on an xDSL or Ethernet physical layer, an IP layer and a UDP layer are positioned on the MAC layer, and an MPEG transport stream is positioned on the UDP layer.

In order to process the Motion Picture Experts Group (MPEG) broadcasting or VOD data inputted through the xDSL regardless of the asynchronous transfer mode (ATM) and Internet protocol (IP) modes, the ATM mode data for guaranteeing quality of service are processed in a hardware type, and the IP mode data for building a broadcasting VOD system at a low cost is processed in a combination type of hardware and software.

The stream transmission operation of each example will now be described with reference to the accompanying drawings.

### FIRST EXAMPLE

As shown in FIG. 2, when the Motion Picture Experts Group (MPEG) transport stream data is positioned on the AAL5 layer of the ATM, the following steps are taken.

In order to transmit 188 bytes of MPEG transport stream data as 53 bytes of ATM cell, one transport stream is segmented in four ATM cell payloads. That is, the asynchronous transfer mode (ATM) cell inputted through the very high bit-rate digital subscriber line (VDSL) is inputted to the ATM control unit 103 through the VDSL transmitting/receiving unit 101 of FIG. 1.

The asynchronous transfer mode (ATM) control unit 103 compares the virtual path identifier/virtual channel identifier (VPI/VCI) values corresponding to the addresses ofthe ATM cells transmitted from the very high bit-rate digital subscriber line (VDSL) transmitting/receiving unit 101, extracts valid cells, and transmits the valid cells to the transport stream forming unit 106.

The transport stream forming unit 106 removes 5 bytes of heads from 53 bytes of ATM cells in a hardware type, and also removes 1 byte of overhead information from 48 bytes of payloads.

Accordingly, the transport stream forming unit 106 forms 188 bytes of MPEG transport stream by reassembling 47 bytes of four ATM cells whose overhead information has been removed, and transmits the Motion Picture Experts Group (MPEG) transport stream to the MPEG decoding unit 107 in a physical MPEG transport stream type.

The MPEG decoding unit 107 decodes the Motion Picture Experts Group (MPEG) transport stream transmitted from the transport stream forming unit 106 in a hardware type, and transmits the decoded transport stream to the encoding unit 108.

The encoding unit 108 format_transforms (encodes) the decoded transport stream transmitted from the Motion Picture Experts Group (MPEG) decoding unit 107 to be displayed on the video display 200, and transmits the encoded transport stream to the video display 200. The video display 200 plays back the encoded video/voice signals from the encoding unit 108.

On the other hand, when receiving the Motion Picture Experts Group (MPEG) transport stream and the Internet data together, the very high bit-rate digital subscriber line (VDSL) transmitting/receiving unit 101 transmits the MPEG transport stream and the Internet data to the ATM control unit 103.

The ATM control unit 103 extracts the virtual path identifier/virtual channel identifier (VPI/VCI) values corresponding to the addresses of the asynchronous transfer mode (ATM) cells for the Motion Picture Experts Group (MPEG) transport stream and the Internet data, and decides or determines whether the cells are MPEG transport stream cells or IP packet cells. For example, when the VPI/VCI value is 0/41, the cell is the MPEG transport stream data, and when the VPI/VCI value is 0/32, the cell is the IP packet.

That is, when the VPI/VCI value of the ATM cell is 0/41, the ATM control unit 103 regards the cell as the Motion Picture Experts Group (MPEG) transport stream cells, and transmits the cells to the transport stream forming unit 106, and when the VPI/VCI value of the ATM cell is 0/32, the ATM control unit 103 regards the cell as the IP packet (general Internet data), and transmits the cell to the processor 109.

The transport stream forming unit 106 reassembles the asynchronous transfer mode (ATM) cells, and transmits the reassembled data to the Motion Picture Experts Group (MPEG) decoding unit 107, and the processor 109 reassembles the ATM cells from the ATM control unit 103, and routes the reassembled packet to the encoding unit 108 as the very high bit-rate digital subscriber line (VDSL) modem. Here, the detailed operation thereof has been described above.

As a result, in the first example, the Motion Picture Experts Group (MPEG) transport stream is inputted to the very high bit-rate digital subscriber line (VDSL) in the ATM mode, and the inputted MPEG transport stream is transmitted to the video display 200 sequentially through the VDSL transmitting/receiving unit 101, the asynchronous transfer mode (ATM) control unit 103, the MPEG decoding unit 107 and the encoding unit 108.

### SECOND EXAMPLE

As depicted in FIG. 3, the Motion Picture Experts Group (MPEG) transport stream is inputted to the very high bit-rate digital subscriber line (VDSL) in the IP over ATM mode. It is similar to the case that an IP packet is inputted through a VDSL modem.

Therefore, the very high bit-rate digital subscriber line (VDSL) transmitting/receiving unit 101 receives the Motion Picture Experts Group (MPEG) transport stream surrounded by an asynchronous transfer mode (ATM) cell head and an IP packet head.

The very high bit-rate digital subscriber line (VDSL) transmitting/receiving unit 101 transmits the inputted MPEG transport stream to the ATM control unit 103, and the ATM control unit 103 compares the virtual path identifier/virtual channel identifier (VPI/VCI) values corresponding to the addresses of the Motion Picture Experts Group (MPEG) transport stream, namely the ATM cells from the VDSL transmitting/receiving unit 101, and extracts valid cells. When the inputted cell is an IP packet, the asynchronous transfer mode (ATM) control unit 103 transmits the cell to the processor 109.

The processor 109 reassembles the ATM cells from the ATM control unit 103, removes IP and UDP heads in a software type, and transmits the Motion Picture Experts Group (MPEG) transport stream to the MPEG decoding unit 107 through a direct memory access (DMA) channel.

The MPEG decoding unit 107 decodes the Motion Picture Experts Group (MPEG) transport stream from the processor 109 in a hardware type, and transmits the decoded transport stream to the encoding unit 108.

The encoding unit 108 format_transforms (encodes) the decoded transport stream from the Motion Picture Experts Group (MPEG) decoding unit 107 to be displayed on the video display 200, and transmits the encoded transport stream to the video display 200. The video display 200 plays back the encoded video/voice signals from the encoding unit 108.

In FIG. 3, head end (HE) equipment is connected directly to the asynchronous transfer mode (ATM) network because the digital broadcasting requires high quality of service, and a VOD server is connected to the IP network because the VOD is mostly provided in the IP mode. The VOD server is useful as a protocol stack for VOD services when both the digital broadcasting and the VOD service are provided through the very high bit-rate digital subscriber line (VDSL).

In this case, the asynchronous transfer mode (ATM) based broadcasting data having the protocol stack of FIG. 2 is processed in a hardware type, and in the IP over ATM based VOD service of FIG. 3, decapsulation of the Motion Picture Experts Group (MPEG) transport stream packet is processed in a software type, and the transport stream is inputted to the MPEG decoding unit 107 through the DMA channel, and decoded in the MPEG decoding unit 107 in a hardware type.

### THIRD EXAMPLE

FIG. 4 illustrates the protocol stack when the very high bit-rate digital subscriber line (VDSL) is formed in the IP mode. Routing and decapsulation of the packet are processed in a software type in the same manner as the Internet data, and MPEG decoding is processed in the Motion Picture Experts Group (MPEG) decoding unit 107 in a hardware type.

The operation will now be explained. The IP based MPEG transport stream inputted to the very high bit-rate digital subscriber line (VDSL) transmitting/receiving unit 101 of FIG. 1 is transmitted to the processor 109 through the first MAC processing unit 104. The first MAC processing unit 104 decides whether the IP packet data transmitted from the VDSL is transmitting/receiving unit 101 is a Motion Picture Experts Group (MPEG) transport stream or general Internet data. When the IP packet is the MPEG transport stream, the first MAC processing unit 104 transmits the transport stream to the MPEG decoding unit 107 through the processor 109. In addition, when the IP packet is the general Internet data, the first MAC processing unit 104 transmits the data to the encoding unit 108 through the processor 109.

When the data transmitted from the first MAC processing unit 104 is the Motion Picture Experts Group (MPEG) transport stream, the processor 109 removes IP and UDP heads in a software type, and transmits the MPEG transport stream to the MPEG decoding unit 107 through the DMA channel.

The MPEG decoding unit 107 decodes the MPEG data transmitted from the processor 109, and transmits the decoded data to the video display 200 through the encoding unit 108. The decoding and encoding operations are identical to those of the first and second examples, and thus are not explained.

As a result, when the MPEG transport stream is received through the very high bit-rate digital subscriber line (VDSL) in the IP mode, the MPEG transport stream is transmitted to the video display 200 through the VDSL transmitting/receiving unit 101, the first MAC processing unit 104, the processor 109, the MPEG decoding unit 107 and the encoding unit 108.

On the other hand, the digital settop box 100 of FIG. 1 serves as the very high bit-rate digital subscriber line (VDSL), and thus basically includes an Ethernet port. In the present invention, the IP based MPEG transport stream can be received and processed through the Ethernet port, which can be easily understood by those skilled in the art.

Here, a protocol stack identical to the protocol stack of FIG. 4 is used, and the operation is identical to the first and second examples except that the MPEG transport stream data is inputted not to the very high bit-rate digital subscriber line (VDSL) transmitting/receiving unit 101 but to the Ethernet transmitting/receiving unit 102. When the IP based MPEG transport stream is inputted through the Ethernet transmitting/receiving unit 102, the MPEG transport stream is transmitted to the processor 109 through the second MAC processing unit 105. That is, the two MAC processing units are formed so that the first MAC processing unit 104 can be connected to the VDSL transmitting/receiving unit 101, and the second MAC processing unit 105 can be connected to the Ethernet transmitting/receiving unit 102.

As a result, when the IP based MPEG transport stream is inputted through the Ethernet transmitting/receiving unit 102, the MPEG transport stream is transmitted to the video display 200 sequentially through the Ethernet transmitting/receiving unit 102, the second MAC processing unit 105, the processor 109, the MPEG decoding unit 107 and the encoding unit 108.

According to the operation for controlling the digital transport stream on the digital settop box in each example, the transport stream can be controlled regardless of physical elements of the input port such as the very high bit-rate digital subscriber line (VDSL) and the Ethernet, and VDSL types such as the ATM mode and IP mode. In addition, the Internet data service can be provided in any cases in the ATM mode, regardless of that the MPEG transport stream is positioned on the AAL5 layer or the IP data is directly positioned thereon.

Table 1 shows the number of service available cases in each example.

TABLE 1

| | | | | |
|---|---|---|---|---|
| VDSL | ATM cell | MPEG TS (FIG. 2) | | Case 1 |
| | | IP packet | MPEG TS | Case 2 |
| | | | (FIG. 3) | |
| | | | General Internet | Case 3 |
| | | | Data | |
| | IP packet | MPEG TS (FIG. 4) | | Case 4 |
| | | General Internet Data | | Case 5 |
| Ethernet | IP packet | MPEG TS (FIG. 4) | | Case 6 |
| | | General Internet Data | | Case 7 |

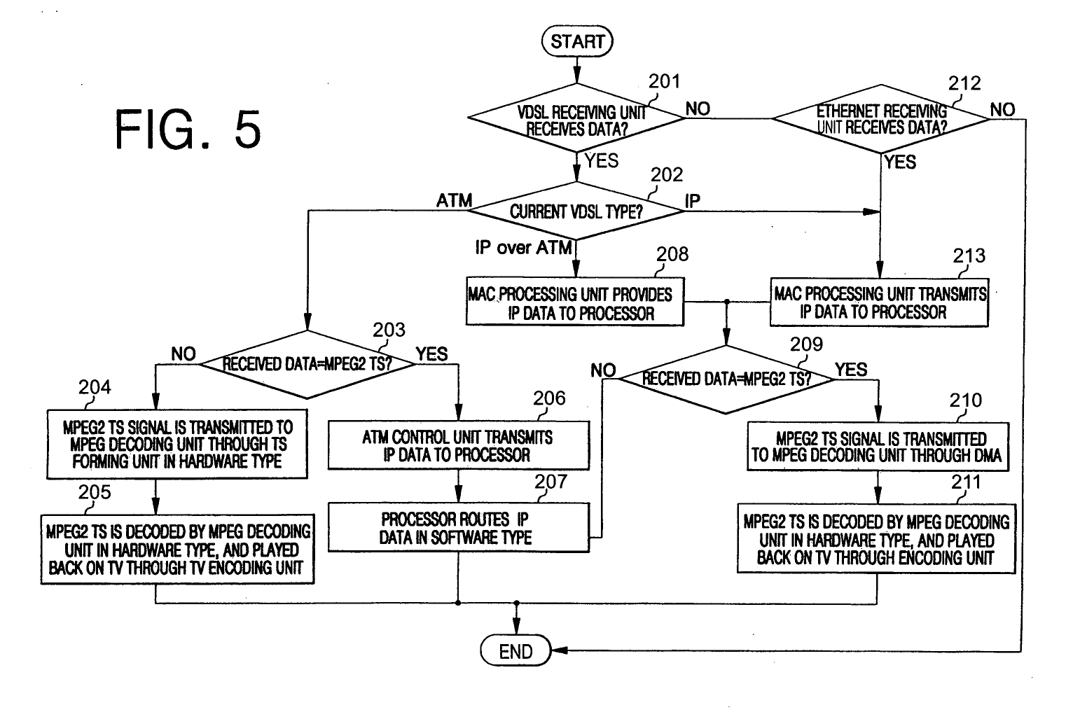

The method for controlling the digital transport stream on the digital settop box including the number of service available cases of Table. 1 will now be described step by step with reference to FIG. 5.

FIG. 5 is a flowchart showing sequential steps of a method for controlling a digital transport stream on a digital settop box, in accordance with the principles ofthe present invention. FIG. 5 is a flowchart showing sequential steps of the method for controlling the digital transport stream on the digital settop box in accordance with an exemplary embodiment of the present invention.

At step 201, a decision is made regarding whether the veryhighbit-rate digital subscriber line (VDSL) transmitting/receiving unit 101 of FIG. 1 receives data.

At step 202, when the very high bit-rate digital subscriber line (VDSL) transmitting/receiving unit 101 receives the data, a VDSL type of the data is confirmed. That is, whether the data is an ATM mode data, IP mode data or IP over ATM mode data is confirmed.

At step 203, when the data received in the very high bit-rate digital subscriber line (VDSL) transmitting/receiving unit 101 is the asynchronous transfer mode (ATM) mode data, whether the data is a Motion Picture Experts Group (MPEG) transport stream is confirmed.

At step 204, when the data received in the very high bit-rate digital subscriber line (VDSL) transmitting/receiving unit 101 is the MPEG transport stream, the MPEG transport stream signal is transmitted to the MPEG decoding unit 107 through the transport stream forming unit 106 of FIG. 1. That is, the asynchronous transfer mode (ATM) control unit 103 of FIG. 1 compares virtual path identifier/virtual channel identifier (VPI/VCI) values corresponding to addresses of the ATM cells inputted through the VDSL transmitting/receiving unit 101, extracts valid cells, and transmits the valid cells to the transport stream forming unit 106, and the transport stream forming unit 106 removes 5 bytes of heads from 53 bytes of ATM cells in a hardware type, and also removes 1 byte of overhead information from 48 bytes of payloads.

Accordingly, the transport stream forming unit 106 forms 188 bytes of MPEG transport stream by reassembling 47 bytes of four ATM cells whose overhead information has been removed, and provides the transport stream to the MPEG decoding unit 107 in a physical MPEG transport stream signal type.

At step 205, the MPEG decoding unit 107 decodes the MPEG transport stream transmitted from the transport stream forming unit 106 in a hardware type, and transmits the decoded transport stream to the video display (for example, TV) through the encoding unit 108 to play back video/voice signals.

At step 206, however, when the data received in the very high bit-rate digital subscriber line (VDSL) transmitting/receiving unit 101 is not the MPEG transport steam but the IP data in step 203, the asynchronous transfer mode (ATM) control unit 103 extracts virtual path identifier/virtual channel identifier (VPI/VCI) values corresponding to addresses of the ATM cells for the IP packet data, and transmits the corresponding cells to the processor 109.

At step 207, therefore, the processor 109 reassembles the asynchronous transfer mode (ATM) cells transmitted from the ATM control unit 103, and routes the reassembled IP packet to the encoding unit 108 as the very high bit-rate digital subscriber line (VDSL) modem.

At step 208, on the other hand, when the very high bit-rate digital subscriber line (VDSL) type of the data received in the VDSL transmitting/receiving unit 101 is the IP over ATM mode in step 202, the asynchronous transfer mode (ATM) control unit 103 extracts virtual path identifier/virtual channel identifier (VPI/VCI) values corresponding to addresses of the ATM cells for the IP data transmitted from the VDSL transmitting/receiving unit 101, and transmits the corresponding cells to the processor 109.

At step 209, the processor 109 confirms whether the cell transmitted from the asynchronous transfer mode (ATM) control unit 103 is a Motion Picture Experts Group (MPEG) transport stream or IP packet cell. For example, when the VPI/VCI value is 0/41, the cell is the MPEG transport stream data, and when the VPI/VCI value is 0/32, the cell is the IP packet.

At step 210, accordingly, when the VPI/VCI value of the ATM cell is 0/41, the processor 109 regards the cell as the MPEG transport stream data, reassembles the asynchronous transfer mode (ATM) cells transmitted from the ATM control unit 103, and transmits the reassembled MPEG transport stream data to the MPEG decoding unit 107 through the direct memory access (DMA) channel.

At step 211, the MPEG decoding unit 107 decodes the MPEG transport stream transmitted from the processor 109 in a hardware type, and transmits the decoded transport stream to the video display (for example, TV) through the encoding unit 108 to play back video/voice signals.

At step 207, however, when the IP data transmitted from the asynchronous transfer mode (ATM) control unit 103 is the IP packet, namely general Internet data in step 209, the processor 109 reassembles the ATM cells from transmitted the ATM control unit 103, and routes the reassembled IP packet to the encoding unit 108 as the very high bit-rate digital subscriber line (VDSL) modem.

At step 213, in addition, when the very high bit-rate digital subscriber line (VDSL) type of the data received in the VDSL transmitting/receiving unit 101 is the IP mode in S102, the first MAC processing unit 104 of FIG. 1 transmits the received IP mode data to the processor 109.

At step 209, the processor 109 decides whether the IP data inputted to the very high bit-rate digital subscriber line (VDSL) transmitting/receiving unit 101 is a Motion Picture Experts Group (MPEG) transport stream or general Internet data.

At step 210, when the IP data is the MPEG transport stream, the processor 109 reassembles the ATM cells transmitted from the ATM control unit 103, and transmits the reassembled MPEG transport stream data to the MPEG decoding unit 107 through the direct memory access (DMA) channel.

At step 211, the MPEG decoding unit 107 decodes the MPEG transport stream from the processor 109 in a hardware type, and transmits the decoded transport stream to the video display (for example, TV) through the encoding unit 108 to play back video/voice signals.

When the IP mode data is the general Internet data instep 209, the operation of steps 106 and 107 are performed.

At step 212, when the very high bit-rate digital subscriber line (VDSL) transmitting/receiving unit 101 does not receive a data in S101, whether the Ethernet transmitting/receiving unit 102 receives a data is decided.

At step 213, when the Ethernet transmitting/receiving unit 102 receives the data, namely an IP data, the second MAC processing unit 105 transmits the IP mode data to the processor 109. Here, data reception from the Ethernet is all performed in the IP mode.

At step 209, the processor 109 confirms whether the IP data inputted to the Ethernet transmitting/receiving unit 102 is a Motion Picture Experts Group (MPEG) transport stream or general Internet data.

At step 210, when the IP data is the MPEG transport stream, the processor 109 reassembles the ATM cells transmitted from the ATM control unit 103, and transmits the reassembled MPEG transport stream data to the MPEG decoding unit 107 through the direct memory access (DMA) channel.

At step 211, the MPEG decoding unit 107 decodes the MPEG transport stream transmitted from the processor 109 in a hardware type, and transmits the decoded transport stream to the video image display (for example, TV) through the encoding unit 108 to play back video/voice signals.

As a result, in accordance with the method for controlling the digital transport stream on the digital settop box, the transport stream can be controlled regardless of physical elements of the input port such as the very high bit-rate digital subscriber line (VDSL) and the Ethernet, and VDSL types such as the ATM mode and IP mode. In addition, the Internet data service can be provided in any cases in the ATM mode, regardless of that the MPEG transport stream is positioned on the AAL layer or the IP data is directly positioned thereon.

The apparatus and method for controlling the digital transport stream on the digital settop box in accordance with the present invention have the following advantages:

Firstly, the apparatus controls the ATM mode and IP mode broadcasting or VOD streams on one xDSL settop box. Accordingly, the apparatus can provide services when the broadcasting HE equipment or VOD server is connected to the ATM network or IP network.

Secondly, the apparatus smoothly copes with network construction by providing services in the ATM mode in an environment requiring high quality of service, and in the IP mode in an environment requiring a low network building cost. Especially, when the broadcasting is connected to the ATM network and the VOD is connected to the IP network, the apparatus provides services without incorporating the networks.

Third, as compared with the ATM mode, the IP mode processes the decapsulation and IP routing of the MPEG transport stream packet in a software type, and thus does not require special hardware. That is, both the ATM mode and the IP mode can be controlled in the same hardware construction as the ATM mode.

Fourth, when the network is connected through the Ethernet without using the xDSL, the apparatus provides the broadcasting or VOD service in the IP mode.

The units 101 and 102 can be put together to be considered as one unit, which can be referred to as a data receiving unit or data receiving means. The units 107 and 108 can be put together to be considered as one unit, which can be referred to as a data transforming unit or data transforming means.

The foregoing paragraphs describe the details of the present invention as it relates to a digital settop box, and more particularly to an apparatus for controlling a digital transport stream on a digital settop box which has independent properties in network construction between a broadcasting head end (HE) equipment or video on demand (VOD) server and the settop box, by controlling a network interfaces and streams for both an asynchronous transfer mode (ATM) network and an Internet protocol (IP) network when a digital broadcasting or video on demand (VOD) stream is supplied to the digital settop box through the digital subscriber line (xDSL).

While the present invention has been particularly shown and described with reference to exemplary embodiments thereof, it will be understood by those skilled in the art that the foregoing and other changes in form and details may be made therein without departing from the spirit and scope of the present invention. While the present invention has been illustrated by the description of embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departing from the spirit and scope of the applicant's general inventive concept.

What is claimed is:

1. An apparatus controlling a digital transport stream on a digital settop box, the apparatus comprising:
a data receiving unit being connected to a digital subscriber line port and an Ethernet port, said data receiving unit receiving signals from at least one selected from among an asynchronous transfer mode network and an Internet protocol network, the signals corresponding to at least one selected from among asynchronous transfer mode digital broadcasting, asynchronous transfer mode video on demand, Internet protocol mode digital broadcasting, and Internet protocol video on demand, said data receiving unit identifying the received signals by determining when the received signals are asynchronous transfer mode data, when the received signals are Internet protocol over asynchronous transfer mode data, and when the received signals are Internet protocol data, said data receiving unit transmitting information corresponding to the received signals in dependence upon the identifying;
an extracting unit determining when the transmitted information corresponds to a portion of a Moving Picture Experts Group transport stream and when the transmitted information corresponds to Internet protocol packet data, said extracting unit extracting valid cells from asynchronous transfer mode cells when the transmitted information includes asynchronous transfer mode cells;
a transport stream forming unit receiving the extracted valid cells, modifying the extracted valid cells to form modified cells, the modifying including removing a predetermined byte of head information and overhead information from the extracted valid cells, forming the Moving Picture Experts Group transport stream by re_assembling the modified cells; and
a data transforming unit transforming the Moving Picture Experts Group transport stream transmitted from said transport stream forming unit to be displayed by a video display.

2. The apparatus of claim 1, with the Moving Picture Experts Group transport stream corresponding to an asynchronous transfer mode Moving Picture Experts Group transport stream.

3. The apparatus of claim 1, with said data receiving unit comprising:
a digital subscriber line receiving unit receiving the asynchronous transfer mode data and the Internet protocol data through a digital subscriber line interface; and
an Ethernet receiving unit receiving the Internet protocol data through an Ethernet interface.

4. The apparatus of claim 1, with said data transforming unit comprising:
a decoding unit decoding the Moving Picture Experts Group transport stream transmitted from said transport stream forming unit; and
an encoding unit encoding the Moving Picture Experts Group transport stream decoded by said decoding unit to be displayed by the video display.

5. The apparatus of claim 4, further comprising:
a processing unit receiving the Internet protocol over asynchronous transfer mode data from said digital subscriber line receiving unit, said processing unit receiving the Internet protocol data from said digital subscriber line receiving unit, said processing unit extracting valid cells from the Internet protocol over asynchronous transfer mode data and the Internet protocol data received from said digital subscriber line;
said processing unit receiving the Internet protocol data from said Ethernet receiving unit and extracting valid cells from the Internet protocol data received from said Ethernet receiving unit.

6. The apparatus of claim 5, further comprising:
a control unit determining when the valid cells extracted from the asynchronous transfer mode cells by said extracting unit correspond to at least one selected from among the Moving Picture Experts Group transport stream and general Internet data, determining when the valid cells extracted from the Internet protocol over asynchronous transfer mode data by said processing unit correspond to at least one selected from among the Moving Picture Experts Group transport stream and the general Internet data, and determining when the valid cells extracted from the Internet protocol data by said processing unit correspond to at least one selected from among the Moving Picture Experts Group transport stream and the general Internet data, said control unit re-assembling the cells in dependence upon the determining, said control unit transmitting the Moving Picture Experts Group transport stream to said decoding unit, and said control unit transmitting the general Internet data to said encoding unit.

7. The apparatus of claim 6, with the Moving Picture Experts Group transport stream corresponding to an asynchronous transfer mode Moving Picture Experts Group transport stream.

8. The apparatus of claim 7, with said data receiving unit comprising:
a digital subscriber line receiving unit receiving the asynchronous transfer mode data and the Internet protocol data through a digital subscriber line interface; and
an Ethernet receiving unit receiving the Internet protocol data through an Ethernet interface.

9. The apparatus of claim 1, further comprising:
a processing unit receiving the Internet protocol over asynchronous transfer mode data from said digital subscriber line receiving unit, said processing unit receiving the Internet protocol data from said digital subscriber line receiving unit, said processing unit extracting valid cells from the Internet protocol over asynchronous transfer mode data and the Internet protocol data received from said digital subscriber line;
said processing unit receiving the Internet protocol data from said Ethernet receiving unit and extracting valid cells from the Internet protocol data received from said Ethernet receiving unit.

10. An apparatus, comprising:
a data receiving unit being connected to at least two ports, said data receiving unit receiving signals from at least one selected from among an asynchronous transfer mode network and an Internet protocol network, the signals corresponding to at least one selected from among asynchronous transfer mode digital broadcasting, asynchronous transfer mode video on demand, Internet protocol mode digital broadcasting, and Internet protocol video on demand, said data receiving unit identifying the received signals by determining when the received signals are asynchronous transfer mode data, when the received signals are Internet protocol over asynchronous transfer mode data, and when the received signals are Internet protocol data, said data receiving unit transmitting information corresponding to the received signals in dependence upon the identifying;
an extracting unit determining when the transmitted information corresponds to a portion of a Moving Picture Experts Group transport stream and when the transmitted information corresponds to Internet protocol packet data, said extracting unit extracting valid cells from asynchronous transfer mode cells when the transmitted information includes asynchronous transfer mode cells; and
a transport stream forming unit receiving the extracted valid cells, modifying the extracted valid cells to form modified cells, the modifying including removing predetermined information from the extracted valid cells, forming the Moving Picture Experts Group transport stream by re_assembling the modified cells, and outputting video data to be transformed and then displayed by a video display.

11. The apparatus of claim 10, the predetermined information including a predetermined byte of head information and overhead information.

12. The apparatus of claim 10, with the at least two ports including a digital subscriber line port and an Ethernet port.

13. The apparatus of claim 12, with said data receiving unit comprising:
a digital subscriber line receiving unit receiving the asynchronous transfer mode data and the Internet protocol data through a digital subscriber line interface; and
an Ethernet receiving unit receiving the Internet protocol data through an Ethernet interface.

14. The apparatus of claim 13, further comprising:
a data transforming unit performing transforming after said transport stream forming unit outputs the video data, said data transforming unit comprising:
a decoding unit decoding the Moving Picture Experts Group transport stream transmitted from said transport stream forming unit; and
an encoding unit encoding the Moving Picture Experts Group transport stream decoded by said decoding unit to be displayed by the video display.

15. The apparatus of claim 14, further comprising:
a processing unit receiving the Internet protocol over asynchronous transfer mode data from said digital subscriber line receiving unit, said processing unit receiving the Internet protocol data from said digital subscriber line receiving unit, said processing unit extracting valid cells from the Internet protocol over asynchronous transfer mode data and the Internet protocol data received from said digital subscriber line;
said processing unit receiving the Internet protocol data from said Ethernet receiving unit and extracting valid cells from the Internet protocol data received from said Ethernet receiving unit.

16. The apparatus of claim 15, further comprising:
a control unit determining when the valid cells extracted from the asynchronous transfer mode cells by said extracting unit correspond to at least one selected from among the Moving Picture Experts Group stream and general Internet data, determining when the valid cells extracted from the Internet protocol over asynchronous transfer mode data by said processing unit correspond to at least one selected from among the Moving Picture Experts Group stream and the general Internet data, and determining when the valid cells extracted from the Internet protocol data by said processing unit correspond to at least one selected from among the Moving Picture Experts Group stream and the general Internet data, said control unit re-assembling the cells in dependence upon the determining, said control unit transmitting the Moving Picture Experts Group stream to said decoding unit, and said control unit transmitting the general Internet data to said encoding unit.

17. The apparatus of claim 10, further comprising:
a data transforming unit performing transforming after said transport stream forming unit outputs the video data, said data transforming unit comprising:
a decoding unit decoding the Moving Picture Experts Group transport stream transmitted from said transport stream forming unit; and
an encoding unit encoding the Moving Picture Experts Group transport stream decoded by said decoding unit to be displayed by the video display.
